(19) United States
(12) Patent Application Publication
(10) Pub. No.: US 2011/0069611 A1
(43) Pub. Date: Mar. 24, 2011

(54) WIRELESS SENSOR NETWORK

(75) Inventors: Tae-Yun Chung, Gangneung-si (KR); Yong-Soon Park, Gangneung-si (KR); Jung-Ho Moon, Yongin-si (KR)

(73) Assignee: Gangneung-Wonju National University Industry Academy Cooperation Group, Gangneung-si (KR)

(21) Appl. No.: 12/992,016

(22) PCT Filed: May 8, 2009
(86) PCT No.: PCT/KR2009/002415

§ 371 Date: Nov. 10, 2010

(30) Foreign Application Priority Data
May 20, 2008 (KR) 10-2008-0046432

(51) Int. Cl. H04L 12/28; H04B 7/14

(52) U.S. Cl. 370/225; 370/315

(57) ABSTRACT

Provided is a wireless sensor network including: a plurality of sensor nodes connected linearly; a sink node connected to the uppermost node among the sensor nodes; a control server; a gateway connected between the sink node and the control server to transmit and receive data; and a plurality of relay gateways. In the case where the plurality of the sensor nodes are divided into a predetermined number of subgroups, the sensor nodes located at the highest levels in the divided subgroups and which are connected to the relay gateways are designated as relay nodes. In the case where an amount of data stored in the relay node exceeds a predetermined threshold value, the relay node transmits the stored data through the connected relay gateway to the control server. Accordingly, in the case where the data of the sensor nodes are increased, it is possible to minimize a problem in that the increased data are lost during transmission.

### TECHNICAL FIELD

The present invention relates to a wireless sensor network, and more particularly, to a wireless sensor network having a distributed TDMA based linear structure and being capable of minimizing a problem in that sensed data sensed by each sensor node are lost during transmission due to a sensor node, of which a capacity of a buffer is limited or in which an error occurs.

### BACKGROUND ART

In general, a wireless sensor network (WSN) may be configured to include sensor nodes, sensor field constructed with groups of sensor nodes, sink nodes which receives information collected by the sensor field, and a gateway which routes the information transmitted from the sink nodes and transmits the information through a broadband communication network to a management control server.

As one of the currently used wireless sensor networks, there is a wireless sensor network having a distributed TDMA based linear structure, which can implement real-time monitored data transmission, low power consumption, and minimization of control packet overhead by using a low duty-cycle MAC algorithm and a time synchronized forwarding mechanism. However, in such a wireless sensor network having the linear structure, in the case where a capacity of a buffer memory built in a sensor node constituting the network is smaller than an amount of data transmitted from the lower level sensor nodes or an amount of sensed data sensed by the sensor node, the portion of the sensing data exceeding the capacity of the buffer memory of the sensor node cannot be transmitted up to the highest level sensor node, that is, the sink node but it may be lost during transmission thereof.

On the other hand, as illustrated in (a) of FIG. 6, conventionally in the case where an error occurs in some nodes N7 and N8 of the wireless sensor network, in order to prepare against a failure of communication in a portion of the sensor nodes constituting the wireless sensor network, each sensor nodes perform a recovery algorithm of recovering the failure of communication. However, as illustrated in (b) of FIG. 6, in the case where the failure of the communication is not recover by such a recovery algorithm, there is a problem in that data of the sensor nodes N1 to N6 located at the lower levels of the sensor nodes N7 and N8, which are in a communication failed state, cannot be transmitted to a sink node N15 but it is lost.

### DISCLOSURE

### Technical Problem

The present invention is to provide a wireless sensor network capable of minimizing a problem in that sensed data exceeding a capacity of a buffer of each sensor node are lost during transmission thereof.

The present invention is also to provide a wireless sensor network capable of minimizing a problem in that sensed data of each of the sensor nodes located at lower levels of some sensor nodes, where errors occur, among the sensor nodes constituting the wireless sensor network are lost due to the sensor nodes where the errors occur.

### Technical Solution

According to a first aspect of the present invention, there is provided a wireless sensor network including: a plurality of sensor nodes connected linearly; a sink node connected to the uppermost node among the sensor nodes; a control server configured to transmit and receive data with respect to the sensor nodes and the sink node and to control operations thereof; a gateway connected between the sink node and the control server to transmit and receive data; a plurality of relay gateways connected to the control server, wherein the plurality of the sensor nodes are divided into a predetermined number of subgroups, the sensor nodes located at the highest levels in the divided subgroups are designated as relay nodes, and each of the relay nodes is connected to each of the relay gateways.

In the wireless sensor network according to the aforementioned first aspect, it is preferable that in the case where an amount of data stored in the buffer of the relay node exceeds a predetermined threshold value, the data stored through the connected relay gateway are transmitted to the control server. In particular, it is more preferable that the relay node determines whether or not the amount of data stored in the buffer reaches the threshold value, wherein in the case where the amount of the data is determined to reach the threshold value, the relay node determines whether or not a portion of the data stored in the buffer is the data that are to be transmitted to the sink node, and wherein in the case where the portion of the data is determined to be the data that are to be transmitted to the sink node, the relay node transmits the data toward the sink node.

According to a second aspect of the present invention, there is provided a wireless sensor network including: a plurality of sensor nodes connected linearly; a sink node connected to the uppermost node among the sensor nodes; a control server; a gateway connected between the sink node and the control server to transmit and receive data; and a plurality of relay gateways connected to the control server, wherein the plurality of the sensor nodes are divided into a predetermined number of subgroups, the sensor nodes located at the highest levels in the divided subgroups are designated as relay nodes, and each of the relay nodes is connected to each of the relay gateways, and wherein in the case where a portion of the sensor nodes is error nodes in a communication-failed state, the relay node of lower subgroups located at lower levels of the subgroups in which the error nodes are included are converted to relay sink nodes, and the relay sink nodes transmit and receive data with respect to the control server through the connected relay gateways.

In the wireless sensor network according to the aforementioned second aspect, it is preferable that a communication-failed state of the sensor node occurs in the case where failure of network link occurs in the sensor node and a recovery of the failure of the network link is failed.

In the wireless sensor network according to the aforementioned second aspect, it is preferable that relay sink node searches for a sensor node located at a higher level, and as a result of the searching, in the case where the sensor node located at the higher level is searched, the relay sink node is reverted to the relay node to recover a communication passage with respect to the searched sensor nodes located at the higher level and to transmit the data through the recovered communication passage.

### ADVANTAGEOUS EFFECTS

As described above, in a wireless sensor network according to the present invention, by using relay nodes and relay gateways, it is possible to minimize a problem in that sensed data exceeding a capacity of a buffer of each sensor node are lost during transmission thereof and to minimize a problem in that sensed data of each of the sensor nodes located at lower levels of some sensor nodes, where errors occur, among the sensor nodes constituting the wireless sensor network are lost due to the sensor nodes where the errors occur.

### DESCRIPTION OF DRAWINGS

FIG. 1 is a diagram illustrating a configuration of a wireless sensor network according to a first embodiment of the present invention.

FIG. 2 is a diagram explaining for data stored in buffers of a portion of sensor nodes according to the first embodiment of the present invention.

FIG. 3 is a flowchart for explaining operations of the wireless sensor network according to the first embodiment of the present invention.

FIG. 4 is a diagram illustrating a configuration of a wireless sensor network according to a second embodiment of the present invention.

FIG. 5 is a flowchart for explaining operations of the wireless sensor network according to the second embodiment of the present invention.

FIG. 6 is a diagram illustrating a configuration of a conventional wireless sensor network.

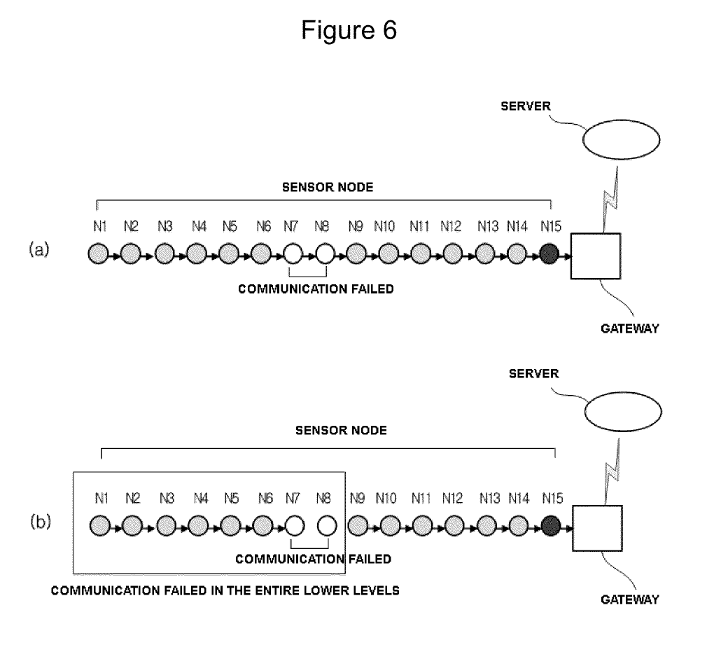

### BEST MODE

Hereinafter, configurations and operations of wireless sensor networks according to embodiments of the present invention will be described with reference to the attached drawings.

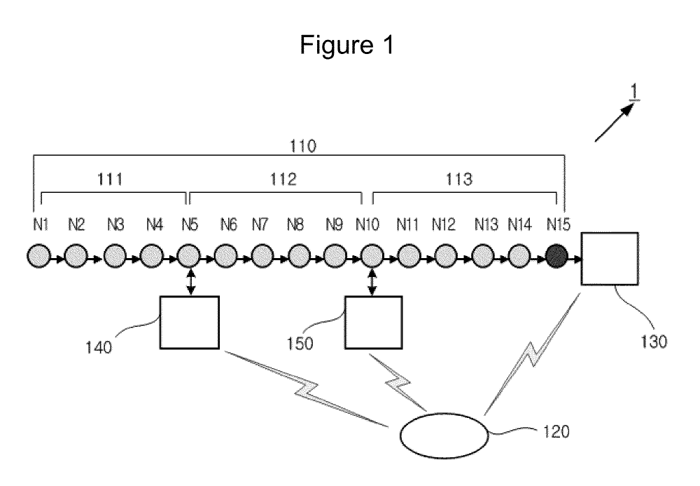

As illustrated in FIG. 1, a wireless sensor network 1 according to the first embodiment of the present invention has a linear structure where data sensed by sensor nodes 110 constituting the network are transmitted toward a sink node N15 located at the highest level. The wireless sensor network 1 is configured according to a distributed TDMA based MAC protocol. As illustrated in FIG. 1, the wireless sensor network 1 according to the first embodiment of the present invention is configured to include a plurality of sensor nodes 110, a control server 120, a gateway 130, relay nodes N5 and N10, and first and second relay gateways 140 and 150. Herein, the relay nodes are designated as the sensor nodes located at the highest levels of subgroups of the sensor nodes, and each of the relay nodes is connected to each of the relay gateways.

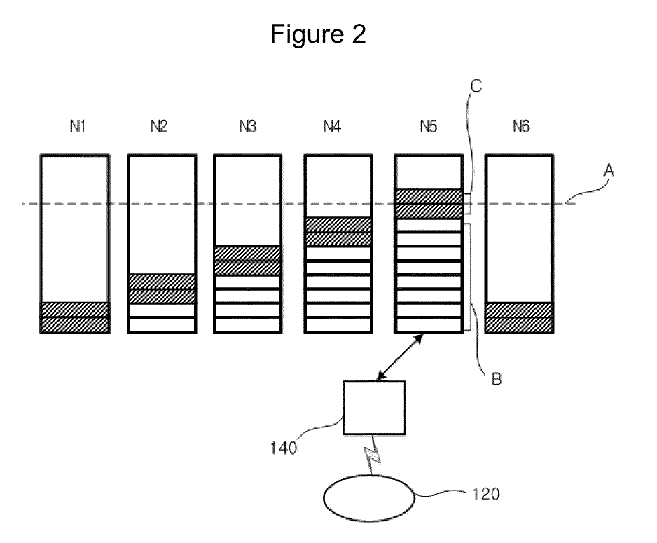

Now, operations of the wireless sensor network 1 according to the first embodiment of the present invention are described in brief. In the case where the data sensed by the sensor nodes 110 constituting the wireless sensor network 1 are increased so that the amount of the data stored in the relay node N5 (N10) exceeds a predetermined threshold value (A in FIG. 2), the relay node N5 (N10) is changed into the relay sink node N5 (N10) capable of functioning as a sink node and connected to the relay gateway 140 (150). The relay gateway 140 (150) transmits the data stored in the relay sink node N5 (N10) to the control server 120. In addition, the relay gateway 140 (150) transmits command data, which are transmitted from the control server 120 to the relay sink node N5 (N10).

Hereinafter, the components of the wireless sensor network 1 according to the first embodiment of the present invention are described in detail.

FIG. 2 illustrates data stored in the buffers of the first node N1 to the sixth node N6.

Each of the sensor nodes 110 generates data by a sensing module (not shown) of sensing given external environments, stores the data in the buffer thereof, and transmits the stored data towards higher sensor nodes.

The control server 120 manages the data transmitted through the sensor nodes 110 and the gateway 130, and controls the overall network.

The gateway 130 connects the sink node N15 and the control server 120. The gateway 130 transmits the data transmitted from the sink node N15 to the control server 120. In addition, the gateway 130 transmits the command data transmitted from the control server 120 to the sink node N15.

In the case where a plurality of the sensor nodes 110 are divided into a predetermined number of subgroups 111, 112, and 113, the relay nodes N5 and N10 are designated as the sensor node N5 and N10 located at the highest levels of the subgroups 111 and 112. The relay nodes N5 and N10 of the subgroups are connected to the relay gateways 140 and 150, respectively. As illustrated in FIG. 1, the wireless sensor network 1 according to the first embodiment of the present invention is configured to include the first subgroup 111 including the first node N1 to the fifth node N5, the second subgroup 112 including the sixth node N6 to the tenth node N10, and the third subgroup 113 including the eleventh node N11 to the fifteenth node N15. Herein, the fifth node N5 and the tenth node N10 correspond to the relay nodes N5 and N10, and the fifteenth node N15 corresponds to the sink node N15. In the case where the data stored in the buffer of the relay node N5 (N10) exceeds the predetermined threshold value A, the relay node N5 (N10) is changed into the relay sink node N5 (N10) functioning as a sink node.

Referring to FIG. 2, the reference numeral N5 corresponds to the relay node, and a non-hatched portion B denotes the data transmitted from the lower sensor nodes N1 to N4, and a hatched portion C denotes the data sensed in the relay node N5. Therefore, as illustrated in FIG. 2, in the case where the amount of the data B (C) stored in the relay node N5 exceeds a threshold value A, the relay node N5 transmits the stored data B (C) to a relay gateway 140. Herein, in FIG. 2, although the threshold value A is about ⅓ of the capacity of the butter, it is preferable that the threshold value A is about ½ of the capacity of the buffer.

The relay gateway 140 (150) connects the relay node N5 (N10) and the control server 120 to transmit the data of the relay node N5 (N10) to the control server 120. After the transmission of the data is completed, the relay sink node N5 (N10) is reverted to the relay node N5 (N10) which performs only the function as the sensor node 110, so that the network is normalized to the original network.

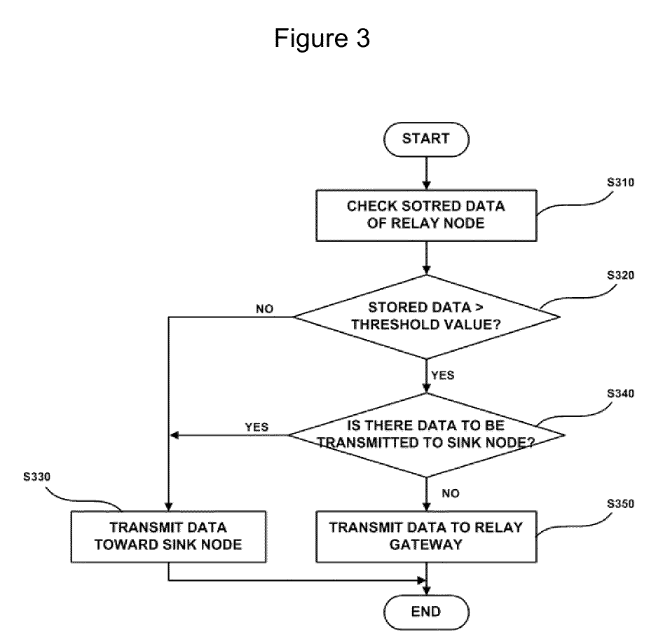

The operations of the wireless sensor network 1 according to the first embodiment of the present invention are described with reference to FIG. 3.

First, each of the relay nodes N5 and N10 checks an amount of data stored in a buffer thereof, that is, an amount of data which are transmitted from lower nodes or which are detected by the relay node (S310). In other words, as illustrated in FIG. 2, the relay node N5 checks the amount of the data B and C stored in the buffer thereof.

Next, as a result of the checking of Step S310, it is determined whether or not the amount of the data stored in the buffer is large than a threshold value A (S320). As illustrated in FIG. 2, it is determined whether or not the data B and C of the relay node N5 are larger than the threshold value A.

If the amount of the data stored in the buffer of the relay node N5 (N10) is smaller than the threshold value A in Step S320, the stored data are transmitted toward the sink node N15 (S330). If the amount of the data stored in the buffer of the relay node N5 (N10) is larger than the threshold value A in Step S320, the relay node N5 (N10) determines whether or not there are data that are to be transmitted to the sink node N15 among the data stored in the buffer thereof (S340).

As a result of the determination of Step S340, if there are data that are to be transmitted to the sink node N15 among the data, Step S330 is performed.

Next, as a result of the determination of Step S340, if there are no data that are to be transmitted to the sink node N15 among the data, the data (B and C in FIG. 2) stored in the buffer of the relay node N5 are transmitted to the relay gateway 140 (150).

Finally, the relay gateway 140 (150) connects the relay node N5 (N10) with the control server 120 so as to transmit the data of the relay sink node N5 (N10) to the control server 120 (S360). In FIG. 2, the first relay gateway 140 transmits the data B and C of the relay sink node N5 to the control server 120.

As described above, in the wireless sensor network 1 according to the first embodiment of the present invention, by using the relay nodes N5 and N10 and the relay gateways 140 and 150, it is possible to minimize the problem in that the sensing data are lost during the transmission when the data of the sensor nodes are increased.

### MODE FOR INVENTION

Hereinafter, configurations and operations of a wireless sensor network according to a second embodiment of the present invention are described with reference to the attached drawings.

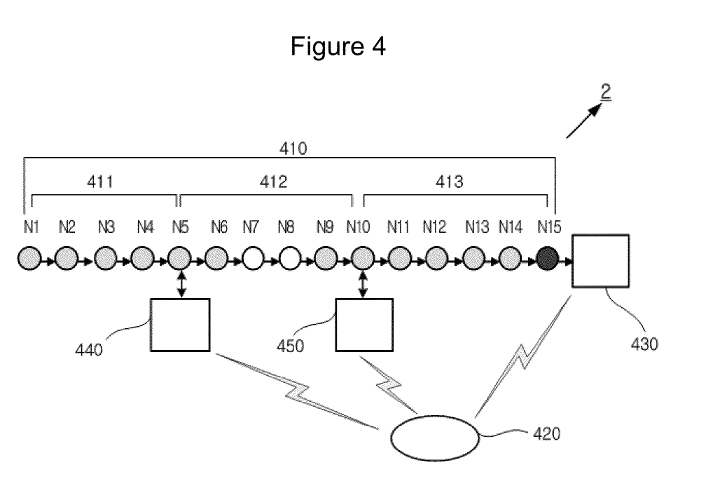

As illustrated in FIG. 4, a wireless sensor network 2 according to the second embodiment of the present invention has the same linear structure as that of the aforementioned wireless sensor network 1 according to the first embodiment. The wireless sensor network 2 is also configured according to a distributed TDMA based MAC protocol.

Now, operations of the wireless sensor network 2 according to the second embodiment of the present invention are described in brief. In the case where an error occurs in a portion of the sensor nodes 410 constituting the wireless sensor network 2, a relay node N5 among the sensor nodes N1 to N6 located at a lower level of error nodes N7 and N8, where the error occurs, is changed into a relay sink node N5 to be connected to a first relay gateway 440. The first relay gateway 440 transmits data of the relay sink node N5 to the control server 420 and command data transmitted from the control server 420 to the relay sink node N5, so that a network of a first subgroup 411 can be configured by the relay sink node N5.

As illustrated in FIG. 4, the wireless sensor network 2 according to the second embodiment of the present invention includes a plurality of the sensor nodes 410, the control server 420, the gateway 430, and relay nodes N5 and N10, and the first and second relay gateways 440 and 450. Hereinafter, the components of the wireless sensor network 2 according to the second embodiment of the present invention are described in detail. However, the description of the same components as those of the aforementioned first embodiment is omitted.

In the case where a plurality of the sensor nodes 410 are divided into a predetermined number of subgroups 411, 412, and 413, the relay nodes N5 and N10 are designated as the sensor nodes located at the highest levels of the subgroups 411 and 412. As illustrated in FIG. 4, the wireless sensor network 2 according to the invention may be divided into the first subgroup 411 including the first node N1 to the fifth node N5, the second subgroup 412 including the sixth node N6 to the tenth node N10, and the third subgroup 413 including the eleventh node N11 to the fifteenth node N15. With respect to the relay nodes N5 and N10, the fifth node N5 and the tenth node N10 correspond to the relay nodes N5 and N10, and the fifteenth node N15 corresponds to the sink node N15.

In the case where a portion of the sensor nodes in each subgroups are the error nodes which are in a communication failed state, in order to prevent the data of the sensor nodes N1 to N6 located at the lower levels of the error nodes N7 and N8 from not being transmitted to the sink node N15 but being lost due to the error nodes N7 and N8, relay nodes of the subgroups located at the lower levels of the subgroup, in which the error nodes are included, are changed into relay sink nodes. In other words, in this case, the relay node N5 of the first subgroup 411 located at the lower level of the second subgroup 412, in which the error nodes N7 and N8 are included, is changed into the relay sink node N5 which functions as a sink node.

Referring to FIG. 4, the seventh node N7 and the eighth node N8 correspond to the error nodes N7 and N8, and the fifth node N5 corresponds to the relay sink node N5. In the case where the relay node N5 is changed into the relay sink node, the relay gateway 440 connects the relay sink node N5 and the control server 420 to transmit the data of the relay sink node N5 to the control server 420 and to transmit the command data transmitted from the control server 420 to the relay sink node N5.

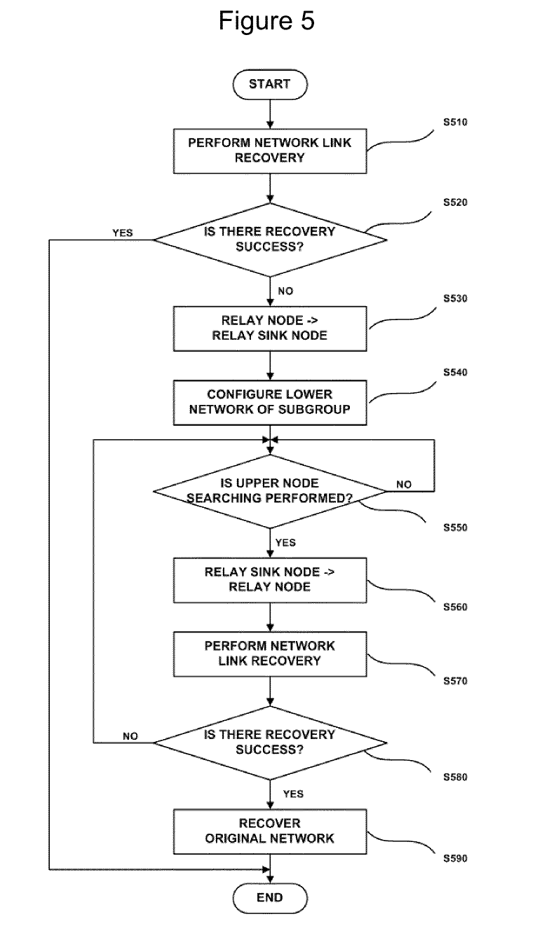

The operations of the wireless sensor network 2 according to the second embodiment of the present invention are described with reference to FIG. 5.

First, in the case where error nodes N7 and N8 occur among the sensor nodes 410 constituting the wireless sensor network 2, sensor nodes where failure of network link occurs due to the error nodes N7 and N8 performs a predetermined network link recovery algorithm (S510). Referring to FIG. 4, in the case where the seventh node N7 and the eighth node N8 are the error nodes N7 and N8, the sixth node N6 and the ninth node N9 performs the network link recovery algorithm.

Next, it is determine whether or not the network link recovery of Step S510 is completed (S520). As a determination result of Step S520, if the network link recovery is completed, the procedure proceeds to Step S590. This means that the original wireless sensor network except for the error nodes N7 and N8 is recovered.

As a determination result of Step S520, if the network link recovery is not completed, the relay node N5 of the first subgroup 411 located at the lower level of the second subgroup 412, in which the error nodes N7 and N8 are included, is changed into the relay sink node N5 which functions as a sink node (S530).

Next, the first relay gateway 440 connects the changed relay sink node N5 and the control server 420 to transmit the data of the relay sink node N5 to the control server 420 and to transmit the command data transmitted from the control server 420 to the relay sink node N5, so that the network of the first subgroup 411 is configured (S540).

Next, in order to recover the network from the communication failed state, the relay sink node N5 determines whether or not to perform a process of searching for the sensor nodes located at the higher levels (S550).

As a determination result of Step S550, if the process of searching for the sensor nodes located at the higher levels is not performed, the procedure proceeds to Step S550. This means that the network of the first subgroup 411 configured in Step S540 is maintained.

As a determination result of Step S550, if the process of searching for the sensor nodes located at the higher levels is performed, and if a higher level sensor node N9 is searched within a predetermined distance, the relay sink node N5 changed in Step S530 is reverted to the relay node N5 (S560).

Next, the relay node N5 reverted in Step S560 performs the same network link recovery algorithm as that of Step S510 (S570).

Next, it is determined whether or not the network link recovery performed in Step S570 is completed (S580).

As a result of the determination of Step S580, if the network link recovery is completed, the wireless sensor network 2 where the relay node N5 and the upper node N9 searched in Step S550 are connected to each other is recovered. Therefore, the network of the first subgroup 411 configured in Step S540 is decomposed.

As a result of the determination of Step S580, if the network link recovery is not completed, the procedure returns to Step S550. This denotes that the network of the first subgroup 411 configured in Step S40 is maintained.

In this manner, in the wireless sensor network 2 according to the second embodiment of the present invention, the network of the first subgroup 411 is configured by using the relay node N5 and the first relay gateway 440, it is possible to minimize the problem that the error node N7 (N8) causes the loss of the sensing data of the sensor nodes N1 to N6 located in the lower level of thereof.

### INDUSTRIAL APPLICABILITY

A wireless sensor network according to the present invention which can transmit sensed data efficiently and safely may be widely used in the field of the wireless sensor network.

1. A wireless sensor network comprising:
a plurality of sensor nodes connected linearly;
a sink node connected to the uppermost node among the sensor nodes;
a control server configured to transmit and receive data with respect to the sensor nodes and the sink node and to control operations thereof;
a gateway connected between the sink node and the control server to transmit and receive data; and
a plurality of relay gateways connected to the control server,
wherein the plurality of the sensor nodes are divided into a predetermined number of subgroups, the sensor nodes located at the highest levels in the divided subgroups are designated as relay nodes, and each of the relay nodes is connected to each of the relay gateways.

2. The wireless sensor network according to claim 1, wherein in the case where an amount of data stored in the buffer of the relay node exceeds a predetermined threshold value, the data stored through the connected relay gateway are transmitted to the control server.

3. The wireless sensor network according to claim 2, wherein the relay node determines whether or not the amount of data stored in the buffer reaches the threshold value, wherein in the case where the amount of the data is determined to reach the threshold value, the relay node determines whether or not a portion of the data stored in the buffer is the data that are to be transmitted to the sink node, and wherein in the case where the portion of the data is determined to be the data that are to be transmitted to the sink node, the relay node transmits the data toward the sink node.

4. A wireless sensor network comprising:
a plurality of sensor nodes connected linearly;
a sink node connected to the uppermost node among the sensor nodes;
a control server;
a gateway connected between the sink node and the control server to transmit and receive data; and
a plurality of relay gateways connected to the control server,
wherein the plurality of the sensor nodes are divided into a predetermined number of subgroups, the sensor nodes located at the highest levels in the divided subgroups are designated as relay nodes, and each of the relay nodes is connected to each of the relay gateways, and
wherein in the case where a portion of the sensor nodes is error nodes in a communication-failed state, the relay node of lower subgroups located at lower levels of the subgroups in which the error nodes are included are converted to relay sink nodes, and the relay sink nodes transmit and receive data with respect to the control server through the connected relay gateway.

5. The wireless sensor network according to claim 4, wherein a communication-failed state of the sensor node occurs in the case where failure of network link occurs in the sensor node and a recovery of the failure of the network link is failed.

6. The wireless sensor network according to claim 4, wherein relay sink node searches for a sensor node located at a higher level, and wherein, as a result of the searching, in the case where the sensor node located at the higher level is searched, the relay sink node is reverted to the relay node to recover a communication passage with respect to the searched sensor nodes located at the higher level and to transmit the data through the recovered communication passage.
